(19) United States
(12) Patent Application Publication
(10) Pub. No.: US 2020/0045978 A1
(43) Pub. Date: Feb. 13, 2020

(54) Novel Plant-Growth Promoting Bacteria and the Use Thereof

(71) Applicants: DCM De Ceuster Meststoffen NV, Sint-Katelijne-Waver (BE); Nederlands Instituut voor Ecologie van de Koninklijke Nederlandse Akademie van Wetenschappen, Wageningen (NL)

(72) Inventors: Viviane Cordovez da Cunha, Wageningen (NL); Inge Hanssen, Sint-Katelijne-Waver (BE); Tom Jozef Justine De Ceuster, Sint-Katelijne-Waver (BE); Victor Jose Carrion-Bravo, Wageningen (NL); Josephus Maria Raaijmakers, Wageningen (NL)

(21) Appl. No.: 16/341,734

(22) PCT Filed: Oct. 23, 2017
(86) PCT No.: PCT/EP2017/077025

§ 371 Date: Apr. 12, 2019

(30) Foreign Application Priority Data
Oct. 21, 2016 (EP) 16195145.4

(51) Int. Cl. A01N 63/02; A01C 1/06

(52) U.S. Cl. CPC A01N 63/02; A01C 1/06

(57) ABSTRACT

Use of a bacterial composition comprising at least one plant growth-promoting bacterium from the Microbacterium genus, for producing biostimulant effects in seeds, seedlings and/or plants, comprising the step of priming said seeds, or seedlings or plants. The bacterial composition particularly comprises Microbacterium strains EC8 and/or all strains sharing >98% nucleotide sequence homology with EC8 at the 16S rRNA gene level (in particular strains EC19 and W283), and/or strains EC6, W211, W236, W219 and W269. The bacterial composition is particularly applied to a plant growth medium, for instance before seedling transplantation. Very good biostimulant effects have been obtained for lettuce, tomato and basil plants.

### FIELD OF THE INVENTION

The present invention relates to certain plant-growth promoting bacteria, to bacterial compositions, more specifically to bacterial cultures such as bacteriologically pure bacterial cultures of novel strains of plant growth-promoting bacteria, and inocula comprising the same.

The present invention further relates to the use of certain plant growth-promoting bacteria with biostimulant effects on seeds, seedlings & plants, such as improved germination and growth promotion of seedlings and plants.

### BACKGROUND OF THE INVENTION

Plant growth-promoting bacteria (PGPB) are associated with many, if not all, plant species and are commonly present in diverse environments. The most widely studied group of PGPB is plant growth-promoting rhizobacteria (PGPR), which colonize the root surfaces and the interface between soil and plant roots, commonly referred to as the rhizosphere. The rhizosphere is an environment where bacteria, fungi and other organisms compete for niches and nutrients and for binding to the root structures of the plant. Both deleterious and beneficial bacteria can colonize plant roots. The presence of PGPB within or near plant roots or seeds can lead to a healthier rhizosphere environment (less colonization of deleterious bacteria) and healthier plants. The free living bacteria are deemed to promote plant growth and health of agricultural crops and increased yield. PGPB that colonize the roots and maintain their benefits throughout the growth cycle of the plant are especially desired for application during germination and early growth or as a seed inoculants of agricultural crops.

The mechanisms that PGPB use in promoting seed germination, seedling and plant growth, are diverse and often plant- or cultivar-specific. Several growth-promoting mechanisms are known. These mechanisms involve supplying the plant with nutrients through e.g. phosphate solubilisation and transport towards the roots and atmospheric nitrogen fixation, or synthesizing phytohormones. As an additional advantage, PGPB can also lead to extensive remodelling of the plant root architecture.

One of the PGPB mechanisms involves the production of volatile organic compounds (VOCs). Ryu et al. (2003) was the first to disclose that bacterial VOCs can promote growth in Arabidopsis. The studied bacteria were Bacillus species, and the VOCs identified for their growth-promoting effects were 2,3-butanediol and 3-hydroxy-butanone.

However, up to date, the majority of seed germination and seedling and plant growth-promoting effects by VOC-producing bacteria have been demonstrated in vitro on nutrient-rich media in sealed petri dishes. Blom et al. (2011) reported that production of plant growth modulating VOCs is widespread among rhizosphere bacteria and strongly depends on culture conditions. Cordovez et al. (2015) reported on the chemical diversity and functions of VOCs that are produced by Streptomyces bacteria originating from a disease-suppressive soil. Hernández-Léon et al. (2015) disclosed a characterization of the plant growth-promoting effects of diffusible and VOCs produced by Pseudomonas fluorescens strains. All these studies are based on in vitro experiments, where the entire plant (roots and shoots) were exposed to the volatiles. Little is known so far on the potential of VOCs in agriculture and in horticulture. It is also not known whether exposure to roots or rather shoot (or both plant parts) is required for growth-promoting effects.

Rather, in the invention, as will be set out below in more detail, the VOC-mediated growth by means of a specific bacterial genus is used with unexpected success for the stimulation of germination of seeds and for growth promotion of seedlings and plants. This was found especially useful is certain classes of plants.

### SUMMARY OF THE INVENTION

It is therefore an object of the present invention to provide a method for biostimulating seeds, seedlings and plants by using certain bacterial cultures and/or inoculums, so as to stimulate seed germination, seedling and/or plant growth via bacterial VOCs, without the need of direct physical contact between the bacteria and the seed, seedling or plant and without the need for seed, seedling or plant colonization. This mode of action is referred as “priming” of seed, seedling or plant.

It is another object to provide novel groups of PGPB, within the genus Microbacterium, that produce VOCs.

It is a further object to provide a bacterial composition comprising such PGPB, which composition suitably comprises one or more of these novel groups of PGPB.

It is a further object to stimulate seed germination, or seedling and/or plant growth by use of certain bacterial cultures and/or inocula in certain plants and crops, such as aromatic herbs, and in particular those the Lamiaceae family, hut also plants and crops such as those of the Solanaceae family, the Asteraceae family and/or the Brassicaceae family. Within the Solanaceae family the use on plants of the Solanum and the Capsicum genera are preferred. Most preferred is the use on plants of the Solanum genus, also known as Solanoideae, including potato, tomato and eggplant. Tomato plants are of particular interest. Within the Asteraceae family, the use on plants of the Cichorioideae subfamily, and particularly the Cichorieae tribe, also known as Lactuceae tribe, is preferred. Well known members thereof include lettuce, chicory, dandelion and salsify. Within the Brassicaceae family, relevant members are cabbage, broccoli, cauliflower and the model plant Arabidopsis thaliana.

According to a first aspect, the invention relates to the use of a bacterial composition comprising at least one strain from the Microbacterium genus, for producing biostimulant effects in seeds, seedlings and/or plants, comprising the step of priming the seeds, or the seedling or plant, wherein the seed, seedling or plant is exposed to the Microbacterium strain(s) by inoculation of the bacterial composition on or into a seed germination or plant growth medium at conditions at which the said bacterium from the Microbacterium genus produces volatile organic compounds (VOCs) and wherein the produced VOCs can reach the seeds, seedlings or plants. Thus, the priming of the seeds, seedlings or plant results in faster germination of seed and enhanced growth of plant and seedlings without direct physical contact between the bacteria and the seed, seedlings or plant

According to a further aspect, the invention relates to bacterial compositions comprising bacterial strains of at least one of the Microbacterium strains EC6, W211, W219, W236, W269, EC19, EC8, and W283, or any other strain with a genetic correspondence with EC8, as particularly based on 16S rRNA gene sequence, of at least 98%.

According to again a further aspect, the invention relates to the use of a bacterial composition comprising PGPB from the Microbacterium genus by exposure of seeds or roots of a seedling or plant of the Solanum genus of the Solanaceae family for producing biostimulant effects in the seeds, seedlings or plants, and particularly of tomato.

According to another aspect, the invention relates to the use of a bacterial composition comprising PGPB from the Microbacterium genus by exposure of seeds or roots of a seedling or plant of the Cichoreeae within the Asteraceae family for producing biostimulant effects in the seeds, seedlings or plants.

According again to another aspect, the invention relates to the use of a bacterial composition comprising PGPB from the Microbacterium genus by exposure of seeds or roots of a seedling or plant of aromatic herbs for producing biostimulant effects in the seeds, seedlings or plants, and particularly of the Lamiaceae family, and more particularly of basil.

It has been surprisingly found in experiments leading to the present invention, that after exposing without direct—physical—contact the seeds or roots of the seedlings or plants to bacteria of the Microbacterium genus, durable, consistent and measurable enhanced plant growth was observed, also when the seedlings or plants were no longer exposed to the bacterial composition (i.e. no further exposure during the plant growth). This latter effect is referred to here as ‘priming’ and more particularly resulted in an improved germination rate, faster germination and/or growth promotion of the shoot and/or roots of the plant. The improved germination rate could for instance be measured as a higher germination percentage. This new approach is suitable not only for seed germination, or seedlings or plants grown in vitro but also for seeds, seedlings and plants in a soil matrix or other seed germinating medium or plant growth medium or substrate. While the initial experiments indicated specifically significant effects on the growth of root biomass and shoot biomass, it is not excluded and even expected on the basis of the initial experimental evidence as disclosed in the present application as well as further experiments by the applicants, that also other stimulating effects may be obtained, such as a an increased resistance to abiotic stress of plants, especially at the phase of seedlings. In view thereof, the more comprehensive term ‘biostimulant effects’ is used in the present application.

The positive findings on priming were based on a variety of microorganisms within the Microbacterium genus. Best results were obtained for a Microbacterium isolate named EC8 and which was deposited under the Budapest Treaty, while isolates that are phylogenetically closely related based on the 16S rRNA gene sequences are expected to demonstrate similar biostimulant effects. More particularly, similar biostimulant effects on seeds, seedling on plants are expected in the different plant families listed above. It is believed that the priming is based on the exposure of the seed, seedlings or plant by means of the VOCs. Sulphur-containing VOCs are deemed particularly important herein.

In an advantageous embodiment, the priming is carried out without the need of direct contact of the bacteria with the seeds, seedlings or plants respectively and without the need for seed, seedling and/or plant colonization. Thus, the priming is carried out in conditions such that direct contact and/or colonization is not necessary or required. There is thus no need to choose a soil matrix or other seed germinating medium or plant growth medium or substrate such that the bacteria will predominantly move to the seeds or roots or other portions of the seedlings or plants. More specifically stated, there is no need to choose a soil matrix or other seed germinating medium or plant growth medium or substrate such that the bacteria will colonize the seeds or roots or other portions of the seedlings. Hence, there is no need to use a very high density of bacteria around the seeds or the roots of the seedlings or plants to induce priming. Similarly, it is not necessary that bacteria maintain very a high density around the seeds or the roots of the seedlings or plants after priming (such as the first priming event). Rather, the bacteria may even be present in a different medium than the seeds, seedlings or plants respectively, as long as the VOCs released by the bacteria can reach the seeds, seedlings or plants. Such a different medium is for instance physically separated from the medium in which the seeds, seedlings or plants are present. Additionally, the exposure period (i.e. the period of VOCs exposure of the plant materials) may be reduced. Also, the priming may be repeated at a later stage of seedling or plant development.

The priming effect was shown to be due to the VOCs produced by the Microbacterium strains. From initial experiments with the model plant Arabidopsis thaliana, it appears that the VOCs operate by means of up-regulating and down-regulating certain genes in the plant, and more particularly those genes in the plant involved in sulphur and nitrogen metabolism and transport. A variety of sulphur-containing organic compounds were identified as being comprised in the VOCs produced by the bacteria. The importance of this priming effect is first of all that no—physical—contact or colonization of the seeds, seedlings or plants is required. Hence, no direct—physical—contact between the VOCs-producing bacterium and the seeds or roots is needed for the priming effect in accordance with the invention, but the effect is at least obtained via the production of VOCs. This is different than in the prior art that relies on efficient and sustained seed and/or root colonization for stimulation of seed germination, seedling vigour and plant growth and health.

The priming may be carried out in various ways. A first promising approach is priming by seed exposure, for instance before or after they are sown. Alternatively or additionally, the priming may be carried out by root or root primordia exposure of seedlings. Suitably, the seedlings have an age of 0-14 days upon priming. Preferably priming starts at a time between 4 and 10 days after (the start of) sowing seeds, more particularly at a time between 5 and 8 days. In a further embodiment, the priming is carried out by root or root primordia exposure of adult plants, i.e. plants that have grown beyond the stage of seedlings. As specified before, the priming without contact to the seed, seedlings or plant will take effect by means of exposure of VOCs, more particularly Sulphur-containing VOCs.

When priming is carried out by root exposure, the bacterial composition can be added to the soil, growth matrix or substrate, thus in a form of inoculation of the growth medium used, i.e. soil, growth matrix or substrate. This may occur upon sowing, or seedling or plant transfer (such as plant transplantation), or at any suitable moment after sowing and after seedling or plant transfer (or plant transplantation), for instance a period between 2 and 7 days after seedling or plant transfer. For the avoidance of doubt, the term ‘priming’ herein refers to the act of adding the bacterial composition to seeds, seedlings or plants, to a medium where the seeds, seedlings or plants have been placed, or to a separate medium from the ones of seeds, seedlings or plants have been placed, at conditions wherein the relevant bacteria may grow, produce VOCs and that the produced VOCs can reach the seeds, seedlings or plants. Typically, this coincides with the addition itself. Alternatively, the act of priming may be embodied by changing conditions such that the bacteria start producing VOCs. For instance, such change in conditions may be achieved by transfer seed, seedling or plant from a storage environment to a growth environment, more particularly at or above room temperature and in light. The temperature may for instance be in the range of 20 to 40° C., more particularly 25 to about 37° C. The temperature could further be in the range of 15 to 40° C., more preferably from 20 to 30° C.-Suitably, such growth environment is a growth chamber or a greenhouse.

In a preferred implementation, the inoculation of the growth medium is repeated, for instance at a time of 1 day-two weeks, preferably after about 1 week, for instance after 5, 6, 7 or 8 days, to further promote seedling or plant growth. This has been found to provide good results, both for lettuce and tomato plants, resulting in additional weight of the shoot. Inoculation can be also repeated or solely performed after transfer of the seedlings or plants, for instance vegetatively produced plants or micro-propagated plants, into a new growth medium. A single repetition is deemed preferable, though more frequent repetitions are not excluded.

After the priming act, i.e. the exposure of VOCs from the bacterial composition, the seed, seedling and/or plant may be exposed to the VOCs of the bacterial composition during an exposure period. In one embodiment, the exposure period may extend up to harvesting or during the whole cropping/exploitation cycle or whole life cycle of the plant, assuming that the bacteria will survive. In an alternative, preferred embodiment, the exposure period is limited to any suitable period of 1 hour to 7 days, for instance 1-5 days, such as 3-4 days. One advantage of limiting the exposure period is that it may not require environmental introduction of the bacterial strain. The priming is thereto particularly carried out before transplanting seedlings or plants (such as vegetatively multiplied and micro-propagated plants) to a soil environment, including natural soils, and artificial soil media such as rockwool, or any liquid or solid growth substrate. For the avoidance of doubt, an exposure period may be terminated by either removal of the seed, seedling or plant from being exposed to the VOCs of the bacteria by removing the seed, seedling or plant from the germinating or growth medium in which the bacteria have been inoculated for instance, or removal of the bacterium. The latter may be particularly carried out, when the bacterial composition is added to a domain separated from the germinating or growth medium of the seed, seedling or plant, or contained in its own container but with the ability that any produced VOC is transmitted to the seed, seedlings or plant, for instance to the roots of the seedling or plant.

According to a promising embodiment, the plant is obtained from vegetative multiplication or micro-propagation, suitably in vitro or semi-in vitro micro-propagation as known per se, including by cutting and layering processes. In this embodiment, priming is suitably carried out by adding the bacterial composition to the growth medium (more particularly substrate) and by root or root primordia exposure of plants that are vegetatively multiplied or micro-propagated during regeneration stage, during rooting stage, during transfer to a new substrate or at hardening stage for instance. The advantage herein is that the selection of plants that very positively react on the VOCs and/or the bacterial composition is carried out in known manner.

Particularly, in one embodiment, the seed, seedling or plant is exposed to the Microbacterium strain(s) in any type of liquid or solid formulation and thereafter transferred or transplanted to a growth medium. The seed, seedling or plant is exposed to the Microbacterium bacteria in a period of 0-14 days after sowing or after plants obtained from vegetative multiplication or micro-propagation are transferred in a new growth medium.

In a preferred embodiment, the bacterial composition is applied to the growth medium (i.e. soil, growth matrix, or substrate or) with a density of the bacteria from the Microbacterium genus of 5.10³-5.10⁷ cells/gram growth medium, preferably 5.10⁵-5.10⁶ cells/gram growth medium. This relatively low concentration turns out feasible and effective. It is believed that the surprisingly good results are due to the fact that no colonization is needed. Such densities were also used for the growth stimulation of tomato plants. When the growth medium is a soil, the relevant portion of the soil is a top layer of 10 cm.

Furthermore, it was found that the germination rate was increased, in the sense that the percentage of germinated seeds at one week after germination, had increased relative to control, particularly to a percentage above 50% and even above 70%. The difference in germination was reduced after 17 days. Notwithstanding this difference, the observed earlier germination leads thereto that the average shoot size is increased at a predefined moment of evaluation and/or that the duration of germination up to seedlings may be reduced, for instance from 15-20 days to 10 days, i.e. with at least 20% and preferably up to 50% relatively to control. This effect was especially observed for plants of the Solanum genus, and more particularly tomato.

Given the surprisingly good results observed with the use of the Microbacterium bacteria for stimulation of seeds, seedlings and plants of tomato, it cannot be excluded that the biostimulant effect is also or even primarily due to other mechanisms than priming effects in tomato and in plants related to tomato, particularly of the Solanum genus. The biostimulant effect was obtained also upon the use of relatively low densities of bacteria, as specified hereinabove. The biostimulant effect was for instance observed as a significant shoot increase in seedlings, particularly in a period between seeding and two or three weeks thereafter. The effect was particularly significant in a comparison with other plants such as lettuce. The biostimulant effect was also seen in the increased germination rate and/or in an increase in root biomass in seedlings. The biostimulation of tomato and related plants is demonstrated for the Microbacterium strains as specified hereinabove and hereinafter. In one embodiment, use is made of strains isolated from the endosphere rather than the rhizosphere.

It is observed for sake of clarity that the phylogenetic correspondence is identified by means of analysis of the 16S rRNA sequence of the relevant Microbacterium strains. The analysis may be carried out by software programs, which are per se known and defined in scientific literature, as hereinafter will be discussed. The analysis is based on a comparison of strings the composition and order of the nucleotides in the 16 rRNA sequences. The PGPB of the bacterial compositions of the invention may be present as a formulation of a biologically pure strain. Alternatively, two or more strains may be present. In addition to one or more biologically pure bacterial strains, a bacterial composition or formulation may suitably also comprise an acceptable carrier depending on the targeted seeds, seedling or plants and where they are placed to germinate, regenerate, harden or grow for instance. The carrier can include (as an co-formulant additive), but is not limited to, a bacterial growth medium, a dispersant, a surfactant, an additive, water, a thickener, an anti-caking agent, residue breakdown, a composting formulation, a granular application, diatomaceous earth, an oil, a coloring agent, a stabilizer, a preservative or a combination thereof. One of ordinary skill in the art can readily determine the appropriate carrier, if any, to be used taking into consideration factors such as a seed, seedling or plant to which the bacterial composition is to be applied, type of soil, growth matrix or substrate (germination and/or growth), climate conditions, whether the bacterial composition is in liquid, solid or powder form, and the like.

Any acceptable carrier can be used. Such carriers include, but are not limited to, vermiculite, charcoal, sugar factory carbonation press mud, rice husk, carboxymethyl cellulose, peat, perlite, fine sand, calcium carbonate, flour, alum, a starch, talc, polyvinyl pyrrolidone or a combination thereof. Also other plant based material is acceptable as a carrier as known per se to the skilled person.

The additives can comprise, but are not limited to, an oil, a gum, a resin, a clay, a polyoxyethylene glycol, a terpene, a viscid organic, a fatty acid ester, a sulphated alcohol, an alkyl sulfonate, a petroleum sulfonate, an alcohol sulphate, a sodium alkyl butane diamate, a polyester of sodium thiobutant dioctate, a benzene acetonitrile derivative, a proteinaceous material or a combination thereof. The proteinaceous material can include a milk product, wheat flour, soybean meal, blood, albumin, gelatine or a combination thereof.

The thickeners can comprise, but are not limited to, a long chain alkylsulfonate of polyethylene glycol, polyoxyethylene oleate, polysaccharides, gums or a combination thereof. The surfactants, which can also be of biological origin, can contain, but are not limited to, a heavy petroleum oil, a heavy petroleum distillate, a polyol fatty acid ester, a polyethoxylated fatty acid ester, an aryl alkyl polyoxyethylene glycol, an alkyl amine acetate, an alkyl aryl sulfonate, a polyhydric alcohol, an alkyl phosphate or a combination thereof. The anti-caking agents can include, but are not limited to, a sodium salt such as a sodium sulphite, a sodium sulphate, a sodium salt of monomethyl naphthalene sulfonate, a sodium salt of dimethyl naphthalene sulphate or a combination thereof. The anti-caking agent may further or alternatively contain, but is not limited to, a calcium salt, such as calcium carbonate, diatomaceous earth or a combination thereof.

The bacterial composition can be prepared as solid, liquid, gel or powdered formulation as is known in the art. It can for instance be formulated as a liquid formulation for application to plants or to a plant growth medium or a solid formulation for application to plants or to a plant growth medium. When the bacterial composition is prepared as a liquid formulation for application to plants or to a plant growth medium, it can be prepared in a concentrated formulation or a working form formulation (ready-to-use). When the bacterial composition is present as a solid formulation, it can be prepared as a granular formulation, or as capsules or beads. The bacterial composition may further include agrochemicals, bio-active substances or other microorganisms such as fertilizers, micronutrient fertilizer materials, insecticides, herbicides, plant growth amendments, fungicides, molluscicides, aligcides, bacterial (bacteria different from those of the Microbacterium genus) or fungal inoculants or a combination thereof. Suitably, the bacterial composition is provided in concentrated form and may be diluted and mixed with further ingredients prior to its use, for instance when applied to a plant growth medium.

It was observed in preliminary experiments that Microbacterium strains have particularly good plant growth promotion properties obtained by means of priming. The results for Microbacterium strain EC8 4 were deemed excellent, and thus similar results can be expected for all isolates sharing at least 90%, more preferably at least 95% or even at least 98% nucleotide sequence homology at the 16S rRNA gene level. Next to EC8 and all isolates sharing at least 98% nucleotide sequence homology at the 16S rRNA gene level (in particular W283, EC19), also the following strains were shown to exert good priming and biostimulant effects: EC6, W211, W219, W236, W269. The 16S rRNA nucleotide sequences of all these isolates of Microbacterium are presented in Table 1.

The specified examples of Microbacterium isolates sharing at least 98% nucleotide sequence homology at the level of the 16S rRNA gene, and all other isolated from which positive effects on plants have been shown in this application (EC6, W211, W219, W236, W269), may all be used for growth promotion of plants, and particularly by means of exposure of seeds or roots of a seedling or plant of the Solanum genus of the Solanaceae family for producing biostimulant effects in the seeds, seedlings or plants, and particularly of tomato.

Preferably, use is made of a Microbacterium strain that has been isolated as described hereinafter and identified as Microbacterium sp. W283, Microbacterium sp. EC19, Microbacterium sp. EC8, Microbacterium sp. W211, Microbacterium sp. W219, Microbacterium sp. W269, Microbacterium sp. W236, Microbacterium sp. EC6. All these strains were isolated from a single source and show major identity as to the 16S rRNA gene sequences, i.e. generally above 95%. Other strains may also be useful. Further strains were isolated from the same source but showed less identity with respect to the 16S rRNA gene sequences.

Based on the findings in preliminary experiments for representative examples of the new strains and the genetic correspondence, it is expected that the biostimulant effects found for the investigated Microbacterium strains also apply to other strains that are closely related phylogenetically. It is expected that the effects for the investigated strains will further apply to other strains with a resembling genetic identity, for instance with a genetic correspondence based on the 16S rRNA gene of at least 95% as based on multi-sequence alignment found by means of sequence alignment tools, such as for instance those available from EMBL-EBI of Hinxton, Cambridgeshire, UK and available on www.ebi.ac.uk/Tools/msa, more particularly the T-Coffee MSA tool. Preferably, said genetic correspondence is at least 97% or and more preferably even at least 98%.

In an embodiment, the use is applied to vegetables, and more particularly crops from the Solanaceae family the Asteraceae family and/or the Brassicaceae family. Preferred examples of the Solanaceae family are tomato, eggplant, potato, pepper and tobacco. This also includes Cayenne pepper (Capsicum annuum), Chili pepper (Capsicum spp.), Paprika (Capsicum annuum), Preferred examples of the Brassicaceae family are broccoli, cabbage, cauliflower. Preferred examples of the Asteraceae family are lettuce, sunflower, artichokes. Members of the Cichorium subfamily can also be treated in accordance with the invention, for instance Cichorium spinosum, Chicory (Cichorium intybus). In one further embodiment, the use according to the invention may be for the Gramineae family and its members, including wheat, rye, barley, triticale, rice, corn, millet, sorghum, oat.

In another embodiment the use of the Microbacterium sp. is applied to aromatic herbs. Preferred aromatic herbs are those of the Lamiaceae family. Preferred examples are basil, mint, rosemary, sage, savory, marjoram, oregano, hyssop, thyme, lavender, and Perilla.

In general, aromatic herbs may be chosen from Ajwain, carom seeds (Trachyspermum ammi), Akudjura (Solanum centrale), Alexanders (Smyrnium olusatrum), Alkanet (Alkanna tinctoria), Alligator pepper, mbongo spice (mbongochobi), hepper pepper (Aframomum danielli, A. citratum, A. exscapum), Allspice (Pimenta dioica), Angelica (Angelica archangelica), Anise (Pimpinella anisum), Aniseed myrtle (Syzygium anisatum), Annatto (Bixa orellana), Artemisia (Artemisia spp.), Asafoetida (Ferula assafoetida), Avens (Geum urbanum), Avocado leaf (Persea americana), Barberry (Berberis vulgaris and other Berberis spp.), Basil, sweet (Ocimum basilicum), Basil, Holy (Ocimum tenuiflorum), Basil, lemon (Ocimum x citriodorum), Basil, Thai (O. basilicum var. thyrsiflora), Bay leaf (Laurus nobilis), Indian Bay leaf, tejpat, malabathrum (Cinnamomum tamala), Boldo (Peumus boldus), Borage (Borago officinalis), Blue fenugreek, blue melilot (Trigonella caerulea), California bay laurel (Umbellularia californica), Caper (Capparis spinosa), Caraway (Carum carvi), Cardamom (Elettaria cardamomum), Cardamom, black (Amomum subulatum, Amomum costatum), Cassia (Cinnamomum aromaticum), Catnip (Nepeta cataria), Celery (Apium graveolens), Chervil (Anthriscus cerefolium), Chives (Allium schoenoprasum), Cicely (Myrrhis odorata), coriander (Coriandrum sativum), Cinnamons (Cinnamomum burmannii, Cassia vera, Cinnamomum loureiroi, Cinnamomum verum, C. zeylanicum), Cinnamon, white (Canella winterana), Cinnamon myrtle (Backhousia myrtifolia), Clary (Salvia sclarea), Clove (Syzygium aromaticum), Vietnamese Coriander (Persicaria odorata), Costmary (Tanacetum balsamita), Cubeb pepper (Piper cubeba), Cudweed (Gnaphalium spp.), long coriander (Eryngium foetidum), Cumin (Cuminum cyminum), Curry leaf (Murraya koenigii), Curry plant (Helichrysum italicum), Dill (Anethum graveolens), Elderflower (Sambucus spp.), Epazote (Dysphania ambrosioides), Fennel (Foeniculum vulgare), Fenugreek (Trigonella foenum-graecum), Filé powder, gumbo filé (Sassafras albidum), Fingerroot, krachai, temu kuntji (Boesenbergia rotunda), Galangal, greater (Alpinia galanga), Galangal, lesser (Alpinia officinarum), Galingale (Cyperus spp.), Garlic chives (Allium tuberosum), Ginger (Zingiber officinale), Ginger, torch, bunga siantan (Etlingera elatior), Golpar, Persian hogweed (Heracleum persicum), Grains of paradise (Aframomum melegueta), Grains of Selim, Kani pepper (Xylopia aethiopica), Horseradish (Armoracia rusticana), Houttuynia cordata, Huacatay, Mexican marigold, mint marigold (Tagetes minuta), Hyssop (Hyssopus officinalis), Indonesian bay leaf, daun salam (Syzygium polyanthum), Jasmine flowers (Jasminum spp.), Jiaogulan (Gynostemma pentaphyllum), Jimbu (Allium hypsistum), Juniper berry (Juniperus communis), Kaffir lime leaves, Makrud lime leaves (Citrus hystrix), Kala zeera (or kala jira), black cumin (Bunium persicum), Kawakawa (Macropiper excelsum), Keluak, kluwak, kepayang (Pangium edule), Kencur, galangal, kentjur (Kaempferia galanga), Kinh gioi, Vietnamese balm (Elsholtzia ciliata), Kokam seed (Garcinia indica), Korarima, Ethiopian cardamom, false cardamom (Aframomum corrorima), Koseret leaves (Lippia abyssinica), Lavender (Lavandula spp.), Lemon balm (Melissa officinalis), Lemon ironbark (Eucalyptus staigeriana), Lemon myrtle (Backhousia citriodora), Lemon verbena (Lippia citriodora), Lemongrass (Cymbopogon citratus, C. flexuosus, and other Cymbopogon spp.), Leptotes bicolour, Lesser calamint (Calamintha nepeta), Licorice, (Glycyrrhiza glabra), Lime flower, linden flower (Tilia spp.), Lovage (Levisticum officinale), Mace (Myristica fragrans), Mahleb, St. Lucie cherry (Prunus mahaleb), Marjoram (Origanum majorana), Mastic (Pistacia lentiscus), Mint (Mentha spp.), Mountain horopito (Pseudowintera colorata), Musk mallow, abelmosk (Abelmoschus moschatus), Mustard (Brassica nigra, Brassica juncea, Brassica hirta, Sinapis alba), Nigella, kalonji, black caraway, black onion seed (Nigella sativa), Njangsa, djansang (Ricinodendron heudelotii), Nutmeg (Myristica fragrans), Olida (Eucalyptus olida), Oregano (Origanum vulgare, O. heracleoticum, and other species), Cuban Oregano (Plectranthus amboinicus), Orris root (Iris germanica, I. florentina, I. pallida), Pandan flower, kewra (Pandanus odoratissimus), Pandan leaf, screwpine (Pandanus amaryllifolius), Paracress (Acmella oleracea), Parsley (Petroselinum crispum), Pepper (Piper nigrum, Piper longum, Schinus terebinthifolius), Dorrigo Pepper (Tasmannia stipitata, Tasmannia lanceolata), Peppermint (Mentha piperata), Peppermint gum leaf (Eucalyptus dives), Perilla Deulkkae, Kkaennip, Shiso (Perilla frutescens), Peruvian pepper (Schinus molle), Rice paddy herb (Limnophila aromatica), Rosemary (Rosmarinus officinalis), Rue (Ruta graveolens), Safflower (Carthamus tinctorius), Saffron (Crocus sativus), Sage (Salvia officinalis), Saigon cinnamon (Cinnamomum loureiroi), Salad burnet (Sanguisorba minor), Salep (Orchis mascula), Sassafras (Sassafras albidum), Savory (Satureja hortensis, Satureja montana), Sorrel (Rumex acetosa, Rumex acetosella), Spearmint (Mentha spicata), Spikenard (Nardostachys grandiflora, N. jatamansi), Star anise (Illicium verum), Sumac (Rhus coriaria), Sweet woodruff (Galium odoratum), Szechuan pepper, (Zanthoxylum piperitum), Tarragon (Artemisia dracunculus), Thyme (Thymus vulgaris), Thyme, lemon (Thymus x citriodorus), Turmeric (Curcuma longa), Vanilla (Vanilla planifolia), Voatsiperifery (Piper borbonense), Wasabi (Wasabia japonica), Water-pepper, smartweed (Polygonum hydropiper), Watercress (Rorippa nasturtium-aquatica), Wattleseed, Wild thyme (Thymus serpyllum), Willow herb (Epilobium parviflorum), Wintergreen (Gaultheria procumbens), Wood avens, herb bennet (Geum urbanum), Woodruff (Galium odoratum), Wormwood, absinthe (Artemisia absinthium), Yarrow (Achillea millefolium), Zedoary (Curcuma zedoaria).

### BRIEF INTRODUCTION OF THE FIGURES

These and other aspects of the invention will be further elucidated with reference to the following Figures, wherein:

FIG. 1A-C shows the plant shoot and root biomass determined 12, 10 and 7 days after exposure to Microbacterium sp. EC8 for Arabidopsis thaliana, tomato and lettuce seedlings, respectively;

FIGS. 2A-2D shows results for experiments wherein plants were first primed by exposure to Microbacterium sp. EC8 and thereafter transplanted to soil. FIG. 2A-C relate to Arabidopsis thaliana and show the shoot dry weight (in mg), the flower dry weight (in cm) and the number of flowers respectively. FIG. 2D relates to lettuce and shows the shoot dry weight (in mg).

### EXAMPLES

### Example 1: Isolation of Microbacterium from the Rhizosphere

Microbacterium strains were obtained from the rhizosphere (roots with tightly adhering soil) of sugar beet plants (Beta vulgaris cv. Aligator). The soil was previously collected in 2003 and 2004 from an agricultural sugar beet field close to the town of Hoeven, the Netherlands (51° 35′10″N 4° 34′44″E). For the collection of Actinobacteria including Microbacterium from the rhizosphere, sugar beet seeds (cultivar Alligator) were sown in square PVC pots containing 250 g of field soil with an initial moisture content of 10% (v/w). Plants were grown in a growth chamber (24° C.; 180 μmol·m⁻²·s⁻¹ at plant level during 16 h/d; 70% relative humidity) and watered weekly with standard Hoagland solution (macronutrients only). After 3 weeks of plant growth, 1 g of sugar beet roots with adhering soil was suspended in 5 ml of potassium-phosphate buffer (pH7.0). Samples were vortexed and sonicated for 1 min. To enrich for different genera of Actinobacteria, a number of treatments were applied to the soil suspension. The treatments included pre-treatments and incubation in a medium. Pre-treatments included submission to 6% yeast extract (30° C. during 120 min.), rehydration (30° C., 90 min) after centrifugation, submission to 1.5% phenol (30° C., 30 min.) and wet-heating (70° C., 15 min). The media included nystatin, nalidixic acid, trimethoprim and/or delvocid. One pre-treatment was applied. The treatments were based on literature. More details can be found in Cordovez et al. (2015), Supplementary Table S1. Single colonies were picked based on the morphology and purified on fresh agar plates. Strains were stored in glycerol (20%, v/v) at −20 and −80° C.

### Example 2: Isolation of Microbacterium Endophytes

An additional isolation method was used to isolate Microbacterium endophytes. For that, roots of sugar beet seedlings were rinsed with 10 ml of 10 mM MgSO4.7H2O (hereafter: buffer) to remove the rhizospheric soil and washed three times with buffer supplemented with 0.01% Tween 20 (v/v). Subsequently, roots were immersed for 2 min. under slow agitation in 1% (v/v) sodium hypochlorite solution supplemented with 0.01% (v/v) Tween 20 and then rinsed five times with buffer. To confirm that the roots were sterile, surface-sterilized roots were spread on Luria-Bertani (LB; Oxoid Thermo Scientific, Lenexa, USA) and 1/10th strength Tryptic Soy Agar ( 1/10th TSA; Difco, BD Laboratories, Houston, USA) agar plates. In addition, 100 μl of the last rinsing step were also plated. To separate plant from microbial cells, root tissue in buffer was disrupted using a blender. The homogenate was filtered consecutively through 25 μm and 10 μm-mesh cheesecloth to remove plant tissue. The flow through was further cleaned by centrifugation at 500×g for 10 min. Bacterial cells were collected by centrifuging the supernatant at 9500 rpm for 15 min. The pellet, consisting of endophytic microorganisms and plant material, was suspended in 3.5 ml buffer supplemented with Nycodenz® resin (PROGEN Biotechnik, Germany) to a final concentration of 50% (w/v). A Nycodenz density gradient was mounted above the sample by slowly depositing various layers of Nycodenz (3 ml of 35% Nycodenz, 2 ml of 20% Nycodenz, 2 ml of 10% Nycodenz) and the gradient was centrifuged for 45 min. at 8500 rpm (Sorvall HB-6). Endophytic microbiome, visualized as a whitish band, was recovered by pipetting. The recovered cells were washed five times with buffer and centrifuged at 13000 rpm for 5 min. in order to remove the Nycodenz resin. Finally, bacterial cells were suspended in 500 μl of buffer, recovered by quick centrifugation at 16000×g. Samples were frozen in liquid nitrogen and stored at −80° C. For the isolation of single cells, 100 μl were plated on 1/10th TSA medium.

### Example 3: Genetic Characterization of Microbacterium

For the genetic characterization the eight strains (EC8, W283, EC19, W211, W219, W269, W236, and EC6) were characterized by 16S rRNA gene sequencing. PCR amplifications were conducted using primers 8F (5′-AGAGTTTGATCCTGGCTCAG-3′) and 1392R (5′-ACGGGCGGTGTGTACA-3′) or 27F (5′-GAGTTTGATCCTGGCTCAG-3′) and 1492R (5′-ACCTTGTTACGACGACTT-3′). For obtaining DNA, cell suspensions were prepared in TE buffer and centrifuged at 13000 rpm for 10 min. After centrifugation, 2 μl of the supernatants were used for the PCR reactions. PCR products were purified and sequenced at Macrogen Inc. The 16S rRNA gene sequences are presented in Table 1.

TABLE 1
16S rRNA gene sequences of the Microbacterium strains EC8,
W283, EC19, W211, W219, W269, W236 and EC6.

| | |
|---|---|
| EC8 | AGCAACCTGCCCCTGACTCTGGGATAAGCGCTGGAAACGGCGTCTAATACTG |
| | GATACGAGTAGCGATCGCATGGTCAGCTACTGGAAAGATTTTTTGGTTGGGGA |
| | TGGGCTCGCGGCCTATCAGCTTGTTGGTGAGGTAATGGCTCACCAAGGCGTCG |
| | ACGGGTAGCCGGCCTGAGAGGGTGACCGGCCACACTGGGACTGAGACACGGC |
| | CCAGACTCCTACGGGAGGCAGCAGTGGGGAATATTGCACAATGGGCGGAAGC |
| | CTGATGCAGCAACGCCGCGTGAGGGATGACGGCCTTCGGGTTGTAAACCTCTT |
| | TTAGCAGGGAAGAAGCGAGAGTGACGGTACCTGCAGAAAAAGCGCCGGCTA |
| | ACTACGTGCCAGCAGCCGCGGTAATACGTAGGGCGCAAGCGTTATCCGGAAT |
| | TATTGGGCGTAAAGAGCTCGTAGGCGGTTTGTCGCGTCTGCTGTGAAATCCCG |
| | AGGCTCAACCTCGGGCCTGCAGTGGGTACGGGCAGACTAGAGTGCGGTAGGG |
| | GAGATTGGAATTCCTGGTGTAGCGGTGGAATGCGCAGATATCAGGAGGAACA |
| | CCGATGGCGAAGGCAGATCTCTGGGCCGTAACTGACGCTGAGGAGCGAAAGG |
| | GTGGGGAGCAAACAGGCTTAGATACCCTGGTAGTCCACCCCGTAAACGTTGG |
| | GAACTAGTTGTGGGGTCCATT |
| | CCACGGATTCCGTGACGCAGCTAACGCATTAAGTTCCCCGCCTGGGGAGTACG |
| | GCCGCAAGGCTAAAACTCAAAGGAATTGACGGGGACCCGCACAAGCGGCGG |
| | AGCATGCGGATTAATTCGATGCAACGCGAAGAACCTTACCAAGGCTTGACAT |
| | ATACGAGAACGGGCCAGAAATGGTCAACTCTTTGGACACTCGTAAACAGGTG |
| | GTGCATGGTTGTCGTCAGCTCGTGTCGTGAGATGTTGGGTTAAGTCCCGCAAC |
| | GAGCGCAACCCTCGTTCTATGTTGCCAGCACGTAATGGTGGGAACTCATGGGA |
| | TACTGCCGGGGTC |
| W283 | TTGCTGGGTGGATTAGTGGCGAACGGGTGAGTAACACGTGAGCAACCTGCCC |
| | CTGACTCTGGGATAAGCGCTGGAAACGGCGTCTAATACTGGATACGAACAAG |
| | AATCGCATGGTTACTTGTTGGAAAGATTTTTTGGTTGGGGATGGGCTCGCGGC |
| | CTATCAGCTTGTTGGTGAGGTAATGGCTCACCAAGGCGTCGACGGGTAGCCG |
| | GCCTGAGAGGGTGACCGGCCACACTGGGACTGAGACACGGCCCAGACTCCTA |
| | CGGGAGGCAGCAGTGGGGAATATTGCACAATGGGCGGAAGCCTGATGCAGCA |
| | ACGCCGCGTGAGGGATGACGGCCTTCGGGTTGTAAACCTCTTTTAGCAGGGA |
| | AGAAGCGAGAGTGACGGTACCTGCAGAAAAAGCGCCGGCTAACTACGTGCCA |
| | GCAGCCGCGGTAATACGTAGGGCGCAAGCGTTATCCGGAATTATTGGGCGTA |
| | AAGAGCTCGTAGGCGGTTTGTCGCGTCTGCTGTGAAATCCCGAGGCTCAACCT |
| | CGGGCCTGCAGTGGGTACGGGCAGACTAGAGTGCGGTAGGGGAGATTGGAAT |
| | TCCTGGTGTAGCGGTGGAATGCGCAGATATCAGGAGGAACACCGATGGCGAA |
| | GGCAGATCTCTGGGCCGTAACTGACGCTGAGGAGCGAAAGGGTGGGGAGCAA |
| | ACAGGCTTAGATACCCTGGTAGTCCACCCCGTAAACGTTGGGAACTAGTTGTG |
| | GGGTCCATTCCACGGATTCCGTGACGCAGCTAACGCATTAAGTTCCCCGCCTG |
| | GGGAGTACGGCCGCAAGGCTAAAACTCAAAGGAATTGAC |
| EC19 | AGCAACCTGCCCCTGACTCTGGGATAAGCGCTGGAAACGGCGTCTAATACTG |
| | GATACGAACAAGAATCGCATGGTTACTTGTTGGAAAGATTTTTTGGTTGGGGA |
| | TGGGCTCGCGGCCTATCAGCTTGTTGGTGAGGTAATGGCTCACCAAGGCGTCG |
| | ACGGGTAGCCGGCCTGAGAGGGTGACCGGCCACACTGGGACTGAGACACGGC |
| | CCAGACTCCTACGGGAGGCAGCAGTGGGGAATATTGCACAATGGGCGGAAGC |
| | CTGATGCAGCAACGCCGCGTGAGGGATGACGGCCTTCGGGTTGTAAACCTCTT |
| | TTAGCAGGGAAGAAGCGAGAGTGACGGTACCTGCAGAAAAAGCGCCGGCTA |
| | ACTACGTGCCAGCAGCCGCGGTAATACGTAGGGCGCAAGCGTTATCCGGAAT |
| | TATTGGGCGTAAAGAGCTCGTAGGCGGTTTGTCGCGTCTGCTGTGAAATCCCG |
| | AGGCTCAACCTCGGGCCTGCAGTGGGTACGGGCAGACTAGAGTGCGGTAGGG |
| | GAGATTGGAATTCCTGGTGTAGCGGTGGAATGCGCAGATATCAGGAGGAACA |
| | CCGATGGCGAAGGCAGATCTCTGGGCCGTAACTGACGCTGAGGAGCGAAAGG |
| | GTGGGGAGCAAACAGGCTTAGATACCCTGGTAGTCCACCCCGTAAACGTTGG |
| | GAACTAGTTGTGGGGTCCATTCCACGGATTCCGTGACGCAGCTAACGCATTAA |
| | GTTCCCCGCCTGGGGAGTACGGCCGCAAGGCTAAAACTCAAAGGAATTGACG |
| | GGGACCCGCACAAGCGGCGGAGCATGCGGATTAATTCGATGCAACGCGAAGA |
| | ACCTTACCAAGGCTTGACATATACGAGAACGGGCCAGAAATGGTCAACTCTTT |
| | GGACACTCGTAAACAGGTGGTGCATGGTTGTCGTCAGCTCGTGTCGTGAGATG |
| | TTGGGTTAAGTCCCGCAACGAGCGCAACCCTCGTTCTATGTTGCCAGCACGTA |
| | ATGGTGGGAACTCATGGGATACTGCCGGGGTC |
| EC6 | AGCAACCTGCCCCTGACTCTGGGATAAGCGCTGGAAACGGCGTCTAATACTG |
| | GATATGTCCCGTCACCGCATGGTGTGTGGGTGGAAAGATTTTTCGGTTGGGGA |
| | TGGGCTCGCGGCCTATCAGCTTGTTGGTGAGGTAATGGCTCACCAAGGCGTCG |
| | ACGGGTAGCCGGCCTGAGAGGGTGACCGGCCACACTGGGACTGAGACACGGC |
| | CCAGACTCCTACGGGAGGCAGCAGTGGGGAATATTGCACAATGGGCGCAAGC |
| | CTGATGCAGCAACGCCGCGTGAGGGATGACGGCCTTCGGGTTGTAAACCTCTT |
| | TTAGCAGGGAAGAAGCGTGAGTGACGGTACCTGCAGAAAAAGCACCGGCTAA |
| | CTACGTGCCAGCAGCCGCGGTAATACGTAGGGTGCAAGCGTTATCCGGAATT |
| | ATTGGGCGTAAAGAGCTCGTAGGCGGTTTGTCGCGTCTGCTGTGAAATTCCGA |
| | GGCTCAACCTCGGGCTTGCAGTGGGTACGGGCAGACTAGAGTGCGGTAGGGG |
| | AGATTGGAATTCCTGGTGTAGCGGTGGAATGCGCAGATATCAGGAGGAACAC |
| | CGATGGCGAAGGCAGATCTCTGGGCCGTAACTGACGCTGAGGAGCGAAAGGG |
| | TGGGGAGCAAACAGGCTTAGATACCCTGGTAGTCCACCCCGTAAACGTTGGG |
| | AACTAGTTGTGGGGTCCTTTCCACGGATTCCGTGACGCAGCTAACGCATTAAG |
| | TTCCCCGCCTGGGGAGTACGGCCGCAAGGCTAAAACTCAAAGGAATTGACGG |
| | GGACCCGCACAAGCGGCGGAGCATGCGGATTAATTCGATGCAACGCGAAGAA |
| | CCTTACCAAGGCTTGACATACACCAGAACACCCTGGAAACAGGGGACTCTTT |
| | GGACACTGGTGAACAGGTGGTGCATGGTTGTCGTCAGCTCGTGTCGTGAGATG |
| | TTGGGTTAAGTCCCGCAACGAGCGCAACCCTCGTTCTATGTTGCCAGCACGTA |
| | ATGGTGGGAACTCATGGGATACTGCCGGGGTC |
| W211 | GAGCTTGCTCTGTGGGATCAGTGGCGAACGGGTGAGTAACACGTGAGCAACC |
| | TGCCCCTGACTCTGGGATAAGCGCTGGAAACGGCGTCTAATACTGGATATGTG |
| | ACGTGACCGCATGGTCTGCGTTTGGAAAGATTTTTCGGTTGGGGATGGGCTCG |
| | CGGCCTATCAGCTTGTTGGTGAGGTAATGGCTCACCAAGGCGTCGACGGGTA |
| | GCCGGCCTGAGAGGGTGACCGGCCACACTGGGACTGAGACACGGCCCAGACT |
| | CCTACGGGAGGCAGCAGTGGGGAATATTGCACAATGGGCGAAAGCCTGATGC |
| | AGCAACGCCGCGTGAGGGATGACGGCCTTCGGGTTGTAAACCTCTTTTAGCAG |
| | GGAAGAAGCGAAAGTGACGGTACCTGCAGAAAAAGCGCCGGCTAACTACGT |
| | GCCAGCAGCCGCGGTAATACGTAGGGCGCAAGCGTTATCCGGAATTATTGGG |
| | CGTAAAGAGCTCGTAGGCGGTTTGTCGCGTCTGCTGTGAAATCCCGAGGCTCA |
| | ACCTCGGGCCTGCAGTGGGTACGGGCAGACTAGAGTGCGGTAGGGGAGATTG |
| | GAATTCCTGGTGTAGCGGTGGAATGCGCAGATATCAGGAGGAACACCGATGG |
| | CGAAGGCAGATCTCTGGGCCGTAACTGACGCTGAGGAGCGAAAGGGTGGGGA |
| | GCAAACAGGCTTAGATACCCTGGTAGTCCACCCCGTAAACGTTGGGAACTAG |
| | TTGTGGGGTCCATTCCACGGATTCCGTGACGCAGCTAACGCATTAAGTTCCCC |
| | GCCTGGGGAGTACGGCCGCAAGGCTAAAACTCAAAGGAATTGACGGGGACCC |
| | GCACAAGCGGCGGAGCATGCGGATTAATTCGATGCAACGCGAAGAACCTTAC |
| | CAAGGCTTGACATATACGAGAACGGGCCAGAAATGGTCAACTCTTTGGACAC |
| | TCGTAAACAGGTGGTGCATGGTTGTCGTCAGCTCGTGTCGTGAGATGTTGGGT |
| | TAAGTCCCGCAACGAGCGCAAC |
| W236 | CCAGCTTGCTGGGTGGATTAGTGGCGAACGGGTGAGTAACACGTGAGCAACC |
| | TGCCCCTGACTCTGGGATAAGCGCTGGAAACGGCGTCTAATACTGGATATGTC |
| | CCGTCACCGCATGGTGTGCGGGTGGAAAGATTTTTCGGTTGGGGATGGGCTCG |
| | CGGCCTATCAGCTTGTTGGTGAGGTAATGGCTCACCAAGGCGTCGACGGGTA |
| | GCCGGCCTGAGAGGGTGACCGGCCACACTGGGACTGAGACACGGCCCAGACT |
| | CCTACGGGAGGCAGCAGTGGGGAATATTGCACAATGGGCGGAAGCCTGATGC |
| | AGCAACGCCGCGTGAGGGATGACGGCCTTCGGGTTGTAAACCTCTTTTAGCAG |
| | GGAAGAAGCGAGAGTGACGGTACCTGCAGAAAAAGCACCGGCTAACTACGT |
| | GCCAGCAGCCGCGGTAATACGTAGGGTGCAAGCGTTATCCGGAATTATTGGG |
| | CGTAAAGAGCTCGTAGGCGGTCTGTCGCGTCTGCTGTGAAATCCCGAGGCTCA |
| | ACCTCGGGCTTGCAGTGGGTACGGGCAGACTAGAGTGCGGTAGGGGAGATTG |
| | GAATTCCTGGTGTAGCGGTGGAATGCGCAGATATCAGGAGGAACACCGATGG |
| | CGAAGGCAGATCTCTGGGCCGTAACTGACGCTGAGGAGCGAAAGGGTGGGGA |
| | GCAAACAGGCTTAGATACCCTGGTAGTCCACCCCGTAAACGTTGGGAACTAG |
| | TTGTGGGGTCCTTTCCACGGATTCCGTGACGCAGCTAACGCATTAAGTTCCCC |
| | GCCTGGGGAGTACGGCCGCAAGGCTAAAACTCAAAGGAATTGACGGGGACCC |
| | GCACAAGCGGCGGAGCATGCGGATTAATTCGATGCAACGCGAAGAACCTTAC |
| | CAAGGCTTGACATACACGAGAACGGGCCAGAAATGGTCAACTCTTTGGACAC |
| | TCGTGAACAGGTGGTGCATGGTTGTCGTCAGCTCGTGTCGTGAGATGTTGGGT |
| | TAAGTCCCGCAACGAGC |
| W219 | ACCGGAGCTTGCTCTGTGGGATCAGTGGCGAACGGGTGAGTAACACGTGAGC |
| | AACCTGCCCCTGACTCTGGGATAAGCGCTGGAAACGGCGTCTAATACTGGAT |
| | ATGTGACGTGACCGCATGGTCTGCGTTTGGAAAGATTTTTCGGTTGGGGATGG |
| | GCTCGCGGCCTATCAGCTTGTTGGTGAGGTAATGGCTCACCAAGGCGTCGACG |
| | GGTAGCCGGCCTGAGAGGGTGACCGGCCACACTGGGACTGAGACACGGCCCA |
| | GACTCCTACGGGAGGCAGCAGTGGGGAATATTGCACAATGGGCGAAAGCCTG |
| | ATGCAGCAACGCCGCGTGAGGGATGACGGCCTTCGGGTTGTAAACCTCTTTTA |
| | GCAGGGAAGAAGCGAAAGTGACGGTACCTGCAGAAAAAGCGCCGGCTAACT |
| | ACGTGCCAGCAGCCGCGGTAATACGTAGGGCGCAAGCGTTATCCGGAATTAT |
| | TGGGCGTAAAGAGCTCGTAGGCGGTTTGTCGCGTCTGCTGTGAAATCCCGAGG |
| | CTCAACCTCGGGCCTGCAGTGGGTACGGGCAGACTAGAGTGCGGTAGGGGAG |
| | ATTGGAATTCCTGGTGTAGCGGTGGAATGCGCAGATATCAGGAGGAACACCG |
| | ATGGCGAAGGCAGATCTCTGGGCCGTAACTGACGCTGAGGAGCGAAAGGGTG |
| | GGGAGCAAACAGGCTTAGATACCCTGGTAGTCCACCCCGTAAACGTTGGGAA |
| | CTAGTTGTGGGGTCCATTCCACGGATTCCGTGACGCAGCTAACGCATTAAGTT |
| | CCCCGCCTGGGGAGTACGGCCGCAAGGCTAAAACTCAAAGGAATTGACGGGG |
| | ACCCGCACAAGCGGCGGAGCATGCGGATTAATTCGATGCAACGCGAAGAACC |
| | TTACCAAGGCTTGACATATACGAGAACGGGCCAGAAATGGTCAACTCTTTGG |
| | ACACTCGTAAACAGG |
| W269 | TCGACGGTGAACCGGAGCTTGCTCTGTGGGATCAGTGGCGAACGGGTGAGTA |
| | ACACGTGAGCAACCTGCCCCTGACTCTGGGATAAGCGCTGGAAACGGCGTCT |
| | AATACTGGATATGTGACGTGACCGCATGGTCTGCGTTTGGAAAGATTTTTCGG |
| | TTGGGGATGGGCTCGCGGCCTATCAGCTTGTTGGTGAGGTAATGGCTCACCAA |
| | GGCGTCGACGGGTAGCCGGCCTGAGAGGGTGACCGGCCACACTGGGACTGAG |
| | ACACGGCCCAGACTCCTACGGGAGGCAGCAGTGGGGAATATTGCACAATGGG |
| | CGGAAGCCTGATGCAGCAACGCCGCGTGAGGGATGACGGCCTTCGGGTTGTA |
| | AACCTCTTTTAGCAGGGAAGAAGCGAAAGTGACGGTACCTGCAGAAAAAGCG |
| | CCGGCTAACTACGTGCCAGCAGCCGCGGTAATACGTAGGGCGCAAGCGTTAT |
| | CCGGAATTATTGGGCGTAAAGAGCTCGTAGGCGGTTTGTCGCGTCTGCTGTGA |
| | AATCCCGAGGCTCAACCTCGGGCCTGCAGTGGGTACGGGCAGACTAGAGTGC |
| | GGTAGGGGAGATTGGAATTCCTGGTGTAGCGGTGGAATGCGCAGATATCAGG |
| | AGGAACACCGATGGCGAAGGCAGATCTCTGGGCCGTAACTGACGCTGAGGAG |
| | CGAAAGGGTGGGGAGCAAACAGGCTTAGATACCCTGGTAGTCCACCCCGTAA |
| | ACGTTGGGAACTAGTTGTGGGGTCCATTCCACGGATTCCGTGACGCAGCTAAC |
| | GCATTAAGTTCCCCGCCTGGGGAGTACGGCCGCAAGGCTAAAACTCAAAGGA |
| | ATTGACGGGGACCCGCACAAGCGGCGGAGCATGCGGATTAATTCGATGCAAC |
| | GCGAAGAACCTTACCAAGGCTTGACATATACGAGAACGGGCCAGAAATGGTC |
| | AACTCTTTGGACACTCGTAAACAGGTGGTGCATGGTTGTCGTCAGCTCGTGTC |
| | GTGAGATGTTGGGTTAAGTCCCGCAACGAGCGCAACCCTC |

### Example 4: Preliminary Evaluation of Plant Growth Promotion

To test for plant growth-promotion, 7-day-old Arabidopsis thaliana seedlings were exposed to the VOCs emitted by 8 of the Microbacterium strains (EC6, W211, W236, W269, W204, ECB, W283 and W163). A. thaliana seedlings Col-0 (collection of the Department of Phytopathology at Wageningen University, the Netherlands) were exposed to the VOCs from the different strains. Seeds were surface sterilized as described in van de Mortel et al. (2012) and kept in the dark at 4° C. for 3-4 days. Sterile A. thaliana seeds sown on Petri dishes (Ø90 mm) containing 25 ml of 0.5× Murashige and Skoog medium (Murashige & Skoog, 1962) supplemented with 0.5% (w/v) sucrose. Petri dishes were placed inside a larger Petri dish (Ø145 mm), sealed and incubated in a climate cabinet (21° C.; 180 μmol·m⁻²·s⁻¹ at plant level; 16 h/d; 60-70% relative humidity). After 7 days, seedlings were exposed to the VOCs emitted by the Microbacterium strains. For that, Petri dishes (Ø35 mm) containing Microbacterium cultures, previously incubated at 30° C. for 3 days (10 μl; OD600=1), were placed in the larger Petri dish (Ø145 mm) containing the Petri dish (Ø90 mm), with the seedlings. Plates were sealed and returned to growth cabinet. Plant fresh weight was determined after 14 days and plant dry weight was determined after overnight incubation at 65° C. A total of 4-5 replicates were used per treatment. Student's t-Test was performed to determine statistically significant differences compared to the control treatment (plants exposed to medium only).

All Microbacterium strains tested promoted the growth of A. thaliana seedlings. VOCs of the eight Microbacterium strains induced significant increases in shoot and root biomass of A. thaliana, but differed in their effects on root architecture. The results of this preliminary test are summarized in Table 2.

TABLE 2
Overview of screening tests with Arabidopsis plants. The
amounts presented here are dry weight biomass.

| | | Plant growth promotion assay | | | |
|---|---|---|---|---|---|
| | | Shoot biomass | | Root biomass | |
| | | | Relative | | Relative |
| Name | Origin | (mg) | to control | (mg) | to control |
| Control | | 0.6 | | 0.14 | |
| EC6 | endosphere | 1.9 | 3.2 | 0.40 | 2.9 |
| W211 | rhizosphere | 3.2 | 5.3 | 0.40 | 2.9 |
| W236 | rhizosphere | 2.1 | 3.5 | 0.25 | 1.8 |
| W269 | rhizosphere | 2.5 | 4.2 | 0.26 | 1.9 |
| W204 | rhizosphere | 2.3 | 3.8 | 0.25 | 1.8 |
| EC8 | endosphere | 2.1 | 3.5 | 0.46 | 3.3 |
| W283 | rhizosphere | 3.4 | 5.7 | 0.35 | 2.5 |
| W163 | rhizosphere | 1.5 | 2.5 | 0.28 | 2.0 |

It follows that all the Microbacterium strains tested show biostimulant activity in this in vitro assay. Strain EC8 has the biggest impact on root development, while strain W283 has the most pronounced effect on shoot biomass. These strains are therewith the most preferred. However, all tested strains show very positive results with respect to plant growth promotion as well. These positive in vitro results provide an indication that the Microbacterium strains are indeed capable of plant growth promotion. This is confirmed in the further experiments with Microbacterium sp. EC8.

### Example 5: Microbacterium sp. EC8 Identification

Microbacterium sp. EC8 was selected for further experiments. Microbacterium sp. EC8 has been deposited in accordance with the Budapest Treaty at the CBS, Utrecht on 2 Sep. 2016, with accession number CBS141778 and the name Microbacterium sp. EC8 in the name of NIOO-KNAW.

To identify the genetic basis of VOC production in Microbacterium sp. EC8, we sequenced and analyzed its genome. For the DNA isolation, a single colony of Microbacterium sp. EC8 was inoculated in LB medium and incubated for 2 days at 25° C. Prior to DNA isolation, bacterial pellet was collected by centrifugation and mixed with 0.9% NaCl. Suspension was centrifuged and the pellet was washed with 0.9% NaCl three times. Total genomic DNA was extracted using the MasterPure™ Complete DNA and RNA Purification Kit (Epicentre Biotechnologies, Madison, Wis., USA) according to manufacturer's instructions with minor modification (beat beating step was skipped). DNA sequencing of Microbacterium sp. EC8 was performed with PacBio sequencing and subsequent de novo assembly using the Hierarchical Genome Assembly Process (HGAP v3) in the SMRTPortal software v3.0 (Chin et al., 2013). A library of approximately 10 KB was sequenced on the PacBio RS II in two SMRT cells. Reads were filtered for a minimal polymerase read length of 500 bp, a read quality of 0.8 and a minimal subread length of 500 bp. After assembly the remaining InDel and base substation errors in the draft assembly were reduced with two rounds of the Quiver algorithm. The resulting singular contig was checked using a custom script and overlapping ends trimmed. There was no evidence of plasmids in the sequence data.

The assembled Microbacterium sp. EC8 genome consists of a single chromosome of 3.18 Mb with G+C content of 67.5% and 3,101 coding DNA sequences (CDSs).

### Example 6: VOCs from Microbacterium sp. EC8

To study the diversity of the VOCs in more detail, headspace VOCs of cultures of Microbacterium sp. EC8 were collected for 6 days and analyzed by GC-QTOF-MS. Microbacterium cells (100 μl OD600=0.1) were plated on sterile glass Petri dishes (Ø90 mm) containing 20 μl of TSA medium. Petri dishes were sealed and incubated at 30° C. for 6 days. VOC collection started right after plating, and for that, the lids of these Petri dishes were designed with an outlet where the Tenax tubes were connected. Trapped compounds were subjected to Gas Chromatography-Quadrupole Time of Flight-Mass Spectrometry (GC-QTF-MS). Compounds were desorbed from the Tenax tubes in a thermodesorption unit (model UnityTD-100, Markes International Ltd., Llantrisant, UK) at 210° C. for 12 min. (Helium flow 50 ml·min⁻¹) using 1:20 split ratio. Released compounds were focused on a cold trap at −10° C. and introduced into the GC-QTF-MS (Agilent 7890B GC and the Agilent 7200A QTOF, Santa Clara, USA). Compounds were transferred to the analytical column (30 m×0.25 mm ID RXI-5MS, film thickness 0.25 μm; Restek 13424-6850, Bellefonte, Pa., USA) by heating the cold trap to 250° C. for 12 min. Temperature program of the GC oven was: 39° C. for 2 min, from 39° C. to 95° C. at 3.5° C.·min⁻¹, from 95° C. to 165° C. at 6° C.·min⁻¹, 165° C. to 250° C. at 15° C.·min⁻¹ and finally, from 250° C. to 300° C. at 40° C.·min⁻¹ and 20 min. hold at a constant gas flow of 1.2 ml·min⁻¹. Mass spectra were acquired by electron impact ionization (70 eV) with a scanning from m/z 30-400 with a scan rate of 4 scans·s⁻¹. Mass-spectra were analyzed with MassHunter Qualitative Analysis Software B.07.00 (Agilent Technologies, Santa Clara, USA) using the GC-Q-TOF qualitative analysis module. VOCs were selected based on three criteria: peak intensity of at least 104, P<0.05 (t-Test), and fold change (FC)>2. Selected VOCs were tentatively identified by comparison of the mass spectra with those of NIST (National Institute of Standards and Technology, USA) and Wiley libraries and by comparing the experimentally calculated LRI with the literature values.

Table 3 shows 18 VOCs that were detected that were not found in the control (agar medium only) or were detected with peak areas significantly different (t-Test, P<0.05) and at least 2-fold larger than those in the control. The vast majority of VOCs that met these criteria were identified as sulfur-containing compounds. These included sulfur-containing compounds commonly found for other bacterial genera such as dimethyl-disulfide and dimethyl trisulfide, but also more rare compounds such as S-methyl 2-methylpropanethioate and S-methyl pentanethioate. In addition, four ketones, including 3,3,6-trimethylhepta-1,5-dien-4-one (also known as Artemisia ketone), were found in the headspace of Microbacterium sp. EC8 culture.

TABLE 3
Volatile organic compounds emitted by Microbacterium sp. EC8.
VOCs displayed were detected only for Microbacterium sp. EC8
or were significantly different (Student's t-Test, P < 0.05, n = 3) and
detected at peak intensities at least twice as high as in the control
(medium only). Compounds were putatively annotated by comparing
their mass spectra (MS) and calculated retention indices (RI)
with those of NIST and in-house mass spectral libraries and standard.

| Compound | Type of compound | RI |
|---|---|---|
| Cyclopentene | Olefin | 543 |
| 2-butanone | Keton | 600 |
| 2-pentanone | Keton | 688 |
| Methyl thioacetate | Sulphur-containing | 704 |
| (Methyldsulfanyl)methane | Sulphur-containing | 750 |
| [Dimethyl disulfide] | | |
| S-methyl propanethioate | Sulphur-containing | 800 |
| S-Methyl 2-methyl propane | Sulphur-containing | 847 |
| thioate | | |
| 2,4-dithiapenane | Sulphur-containing | 886 |
| 1-(methyldisulfanyl)propane | Sulphur-containing | 888 |
| S-methyl pentane thioate | Sulphur-containing | 940 |
| (Methyltrisulfanyl)methane | Sulphur-containing | 973 |
| [dimethyl trisulfide] | | |
| 3,3,6-trimethyl-hepta-1,5-dien- | Unsaturated ketone | 1051 |
| 4-one [Artemisia ketone) | | |
| ? | Sulphur-containing compound | 1059 |
| Methyl (methylthio)methyl | Sulphur-containing compound | 1122 |
| disulfide | | |
| (methyltetrasulfanyl)methane | Sulphur-containing compound | 1212 |
| [dimethyl tetrasulfide] | | |
| (methylpentasulfanyl)methane | Sulphur-containing compound | 1460 |
| [dimethyl pentasulfide] | | |

### Example 7: Plant Transcriptional Changes Induced by VOCs Emitted by Microbacterium sp. EC8

To understand the molecular mechanisms underlying VOC-mediated plant growth promotion by Microbacterium sp. EC8, RNAseq analysis was performed for Arabidopsis thaliana seedlings exposed for one week to the bacterial VOCs. Total RNA was extracted from shoot and root tissues A. thaliana seedlings exposed to the VOCs from Microbacterium sp. EC8 for one week. Seedlings exposed to TSA medium only were used as control. For the sequencing of plant RNA, total RNA was extracted from roots and shoots. A total of 4 replicates were used, and each replicate consisted of 4 plates with 6 seedlings each in order to obtain enough biomass. RNA was obtained from frozen tissues with Trizol reagent (Invitrogen). The RNA samples were further purified using the NucleoSpin RNA II kit (Macherey-Nagel) and kept at −80° C. until sequencing. For RNA sequencing, samples were processed using the NEBNext Ultra Directional RNA Library Prep Kit for Illumina at ServiceXS (GenomeScan BN., Leiden, The Netherlands). Briefly, mRNA was isolated from the total RNA using the oligo-dT magnetic beads. After fragmentation of the mRNA, cDNA was synthesized, ligated with sequencing adapters and amplified by PCR in order to obtain cDNA libraries. Each cDNA library was individually analyzed for quality and yield using a Fragment Analyzer. cDNA was then clustered and a concentration of 1.6 pM was sequenced with an Illumina NextSeq 500 sequencer.

Illumina sequences were trimmed and filtered with FASTQC with a threshold of 25 (Q>25). Quality-trimmed reads were counted using RSEM software package (Li & Dewey, 2011) transformed into RPKM (Reads Per Kilobases per Million reads). Reads were mapped to the A. thaliana reference genes using the software Bowtie2 v.2.1.0 (Langmead & Salzberg, 2012). The Bioconductor package DESeq2 (Love et al., 2014) was used for normalization and differential expression analyses. The P-value was obtained from the differential gene expression test. FDR (False Discovery Rate) manipulation was used to determine the P-value threshold in multiple tests and analyses. Significant differentially expressed genes (DEGs) were selected using FDR<0.05 and the absolute value of the log 2Ratio≥0.585 (at least 1.5× higher than the expression level in control) as thresholds. Biological interpretation of the DEGs was performed using Cytoscape software with ClueGO plugin (Bindea et al., 2009).

Genes of shoot and root tissues with an adjusted P<0.05 and with a value of log 2Ratio≥0.585 or ≤0.585 (1.5-fold change) were considered as differentially expressed from the non-exposed (control) seedlings. A total of 946 (545 up- and 401 down-regulated) and 1361 (698 up- and 663 down-regulated) differentially expressed genes (DEGs) were identified in shoot and root tissues, respectively. Arabidopsis root tissue displayed a higher number of transcriptional changes compared to shoot tissue. A total of 20 genes involved in sulfur metabolism and transport were found to be differentially expressed in shoot and root tissues upon exposure to VOCs from Microbacterium sp. EC8. Table 4 provides the overview of the differentially expressed genes and the fold change for the types involved in the metabolism of sulphur and nitrogen (nitrate).

TABLE 4
Differentially expressed genes (DEGs) of Arabidopsis thaliana
seedlings exposed to volatile organic compounds (VOCs) emitted by
Microbacterium sp. EC8. One week old seedlings were exposed to VOCs
for one week. DEGs involved in metabolism and transport of sulphur (S)
and nitrate (N) are specified. Fold change was calculated using the log2FC
(VOC exposed seedlings/control).

| | | | | FC | FC |
|---|---|---|---|---|---|
| Code | Name | TYPE | Description | shoots | roots |
| AT1G02500.1 | SAM-1 | S-metabolism | 5-adenosylmethionine synthase | 1.7 | 1.1 |
| AT4G01850.2 | SAM-2 | S-metabolism | 5-adenosylmethionine synthase | 1.7 | −1.1 |
| AT4G13940.1 | MEE58 | S-metabolism | S-adenosyl-L-homocysteine | 2.5 | 2.1 |
| | | | hydrolase | | |
| AT3G23810.1 | SAHH2 | S-metabolism | S-adenosyl-L-homocysteine | 2.1 | 1.6 |
| | | | hydrolase | | |
| AT1G64660.1 | MGL | S-metabolism | methionine gamma-lyase | 3.5 | 2.7 |
| AT5G25980.2 | TGG2 | S-metabolism | thioglucoside glucohydrolase | 2.9 | 1.0 |
| AT1G27130.1 | GSTU13 | S-metabolism | glutathione transferase | 2.8 | 1.3 |
| AT1G78380.1 | GSTU19 | S-metabolism | glutathione transferase | 1.7 | −1.7 |
| AT2G30860.1 | GSTF9 | S-metabolism | glutathione transferase | 2.1 | 1.1 |
| AT2G30870.1 | GSTF10 | S-metabolism | glutathione transferase | 2.3 | 2.2 |
| AT2G29490.1 | GSTU1 | S-metabolism | glutathione transferase | −1.0 | −1.7 |
| AT2G29420.1 | GSTU7 | S-metabolism | glutathione transferase | −1.3 | −3.0 |
| AT3G09270.1 | GSTU8 | S-metabolism | glutathione transferase | −1.2 | −2.2 |
| AT1G74590.1 | GSTU10 | S-metabolism | glutathione transferase | −2.9 | −3.9 |
| AT1G78380.1 | GSTU19 | S-metabolism | glutathione transferase | 1.7 | −1.7 |
| AT4G04610.1 | APR1 | S-metabolism | phosphosulfate reductase | −1.1 | −3.6 |
| AT4G21990.1 | APR3 | S-metabolism | phosphosulfate reductase | −1.2 | −1.9 |
| AT1G78000.2 | SULTR1.2 | S-metabolism | sulfate transporter | −1.9 | −6.9 |
| AT4G02700.1 | SULTR3.2 | S-metabolism | sulfate transporter | 1.0 | −2.0 |
| AT3G12520.2 | SULTR4.2 | S-metabolism | sulfate transporter | −1.6 | −3.4 |
| AT1G08090.1 | NRT2.1 | N-metabolism | nitrate transporter | 1.0 | 14.0 |
| AT3G45060.1 | NRT2.6 | N-metabolism | nitrate transporter | −1.5 | 2.4 |
| AT5G14570.1 | NRT2.7 | N-metabolism | nitrate transporter | −1.7 | 1.5 |
| AT1G77760.1 | NIA1 | N-metabolism | nitrate reductase | 1.0 | 1.6 |
| AT1G37130.1 | NIA2 | N-metabolism | nitrate reductase | −1.5 | −7.3 |
| AT5G40890.1 | CLC-A | N-metabolism | chloride channel | −1.7 | 6.1 |

### Example 8: Plant Growth Promotion In Vitro

### Bacterial Strain

Microbacterium sp. EC8 was grown on Tryptone Soy Broth (Oxoid Thermo Scientific, Lenexa, USA) supplemented with 18 g of technical agar (Oxoid Thermo Scientific, Lenexa, USA) for 3 days at 21° C. Cells were obtained from agar plate and mixed with 10 mM MgSO4.7H20 buffer. Cell density was measured and adjusted to OD600=1 (˜10⁹ cfu·ml⁻¹).

### Plant Material

For the in vitro assays, seeds of Arabidopsis thaliana were surface-sterilized for 3 h by placing seeds in Eppendorf tubes open in a desiccator jar. Two beakers, each containing 50 ml of sodium hypochlorite solution were placed inside, and 1.5 ml of 37% hydrochloric acid was added to each beaker. The desiccator jar was closed, and the seeds were sterilized by chlorine gas.

Eppendorf tubes containing the sterile seeds was kept open in the flow cabinet for 30 min and after that placed on a wet paper filter in a Petri dish. Petri dish was sealed and wrapped in tin foil and kept at 4° C. for 3-4 days. Seeds of lettuce (Lactuca sativa) and tomato (Solanum lycopersicum L.) were surface-sterilized by soaking in 70% ethanol for 2 min., followed by soaking in 1% sodium hypochlorite solution for 20 min. After soaking, seeds were rinsed three times in sterile demi-water. Plants were kept in climate cabinets at 21° C.; 180 μmol·m⁻²·s⁻¹ at plant level; 16 h/d; 70% relative humidity.

### In Vitro Plant Growth Promotion Assay

Sterile seeds of A. thaliana, lettuce and tomato were sown on Petri dishes (Ø90 mm) containing 25 ml of 0.5× Murashige and Skoog medium (Murashige & Skoog, 1962) supplemented with 0.5% sucrose. These Petri dishes (without lids) were kept inside a larger Petri dish (Ø145 mm) which were sealed and kept in the climate cabinet. After four days, seedlings were exposed to the bacterial VOCs or to agar medium by introducing a small Petri dish Ø35 mm) containing a 3-day-old bacterial culture or the agar medium (control). Petri dishes Ø145 mm) were sealed and kept in the climate cabinet.

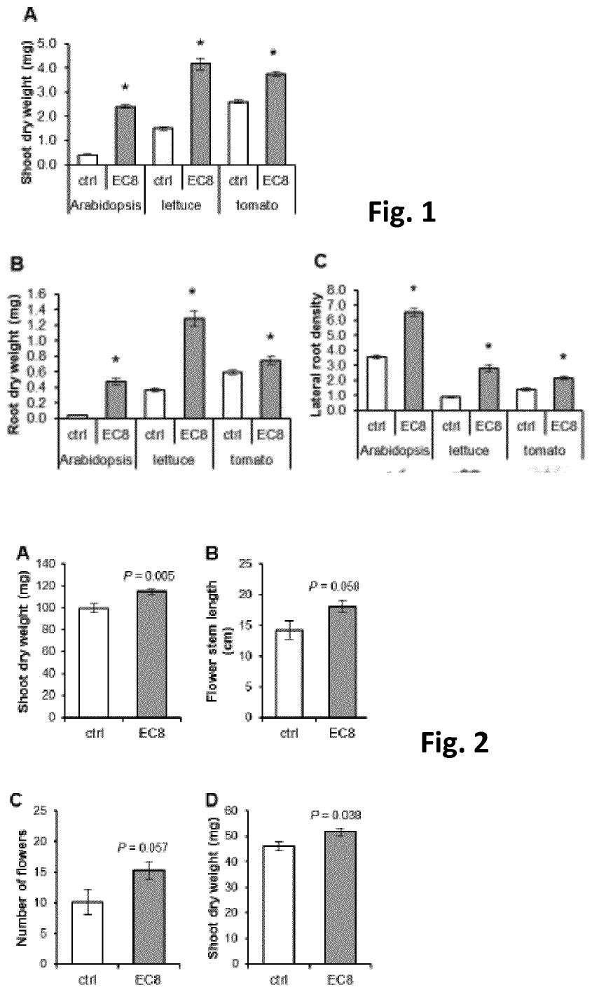

FIG. 1A-C shows the plant shoot and root biomass was determined after 12, 10 and 7 days for Arabidopsis, tomato and lettuce seedlings, respectively. Control seedlings are referred as ‘ctrl’ and were exposed to agar medium only; seedlings exposed to VOCs from EC8 are referred as ‘EC8’; asterisks indicate statistically significant differences between VOC-exposed and control seedlings (Student's t-Test, P<0.05). Upon exposure to the bacterial VOCs, lettuce seedlings showed an increase of 178% in shoot biomass (t-Test, P<0.001), 253% in root biomass (t-Test, P<0.001) and 217% in lateral root density (t-Test, P<0.001); tomato seedlings showed an increase of 44% in shoot biomass (t-Test, P<0.001), 27% in root biomass (t-Test, P=0.038) and 54% in lateral root density (t-Test, P<0.001) (FIG. 1A, B, C) compared to control seedlings (exposed to agar medium only).

### Example 9: In Vitro Priming Effect

To test if VOCs emitted by Microbacterium sp. EC8 could prime plant growth and development, Arabidopsis thaliana and lettuce seedlings were exposed in vitro to the bacterial VOCs and then transplanted to soil. For the in vitro exposure of the seedlings, use was made of the three-compartment set-up described above. Seven-day-old Arabidopsis thaliana and three-day-old lettuce seedlings were exposed for five and three days, respectively. The transplanted plants were kept in plastic pots containing 130 g of potting soil with 40% moisture. A total of 5-9 replicates were used per treatment. A. thaliana shoot biomass, number of flower and length of flower stem were determined 21 days after soil transplantation. Lettuce biomass was determined 13 days after soil transplantation.

FIG. 2A-D shows the results. FIGS. 2A-C relate to A. thaliana and show the shoot dry weight (in mg), the flower dry weight (in cm) and the number of flowers respectively. FIG. 2D relates to lettuce and shows the shoot dry weight (in mg). The results in FIG. 2A-D demonstrate that short VOC-exposure (four days) promoted the growth of A. thaliana and lettuce plants transplanted to and grown in soil. Arabidopsis plants showed a significant increase of 35% in shoot biomass. We also observed increases of 27% in length of the flower stem and of 51% in number of flowers, although these increases were not statistically significant. Lettuce plants showed a significant 12% increase in shoot biomass (t-Test, P=0.038; FIG. 2D). These results demonstrate that a four-day-exposure of A. thaliana and lettuce to VOCs from Microbacterium sp. EC8 is sufficient to trigger plant growth promotion without direct and prolonged contact between the plants and the bacterial strain. To test if a short exposure to the bacterial VOCs had an effect on plant growth, and then transplanted to soil.

### Example 10: Demonstration of Root Exposure

A set of further experiments was set up to verify that the effect of the Microbacterium sp. EC8 is based on root exposure.

In the first set-up, plants and the bacterial culture were kept inside a sterile container for one week allowing exposure of the plant shoots to the bacterial VOCs. Seedlings were sown in pots (inner diameter: 6.5 cm, height: 5 cm) containing potting soil and kept in the climate chamber. Microbacterium sp. EC8 was inoculated on Petri dishes containing TSA medium and incubated for 6 days at 21° C. Ten holes were made on the walls of these Petri dishes to allow diffusion of the bacterial VOCs. Arabidopsis thaliana, lettuce and tomato seedlings were exposed to the bacterial VOCs seven, four and six days after sowing, respectively. After one week of co-cultivation, pots were kept open in the flow cabinet for 30 min. to remove excess of condensation on the pot walls. Plants were exposed three more days and allowed to grow for four days in the absence of the bacterial VOCs. After that, shoot biomass was determined. Exposure to the VOCs emitted by Microbacterium sp. EC8 resulted in a 45% increase of shoot biomass of A. thaliana plants (t-Test, P=0.002). However, no significant increases in shoot biomass were observed for lettuce plants (t-Test, P=0.336) and tomato (t-Test, P=0.837).

In the second experimental set-up, plant roots were exposed to VOCs emitted by Microbacterium sp. EC8 inoculated onto agar medium. To expose only the roots to the bacterial VOCs, we used a pot with two compartments separated by a polyester membrane (5 μm, Nedfilter, Lelystad, The Netherlands). Upper compartment (inner diameter: 5.5 cm, height: 8 cm) was filled with potting soil-sand mixture (1:2 v/v; 25% moisture) where one A. thaliana or lettuce seed was sown. Bottom compartment (inner diameter: 6.5 cm, height: 4.5 cm) was filled with the soil-sand mixture mixed with the bacterial culture (10⁷ cfu·g⁻¹ soil) or a Petri dish (Ø35 mm) containing a three-day-old bacterial culture on TSA medium (initial concentration 10⁹ cfu·ml⁻¹) previously incubated at 21° C. Shoot and root biomass were determined three weeks after sowing. VOCs emitted by Microbacterium sp. EC8 grown on agar medium increased the biomass of A. thaliana shoots (t-Test, P=0.001) and roots (t-Test, P<0.001), and of lettuce shoots (t-Test, P=0.004) and roots (t-Test, P=0.036).

### Example 11: Biostimulant Effect on Lettuce Through Soil Inoculation

Experiments were carried out wherein the bacterial composition of Microbacterium sp. EC8 was inoculated in soil. In a first set of experiments, the effect was tested for lettuce. The EC8 was added to the soil in two different densities: 10⁶ and 10⁷ cells·g⁻¹ soil, which is hereinafter referred to as “low density” and “high density” respectively. Additionally control experiments without Microbacterium sp. EC8 were carried out. Use was made of 100% potting soil, with 8 plants/pot and 10 replicates. The growth took place in a growth chamber that was held at 21° C. during day and night at 70% relative humidity. Tests were carried out wherein the bacterial composition was added to the soil at sowing and at sowing and after 1 week. These two administration protocols are hereinafter also referred to as “single addition” and “two addition” respectively. Table 5 shows the results of shoot at harvesting after 2 weeks.

TABLE 5
Growth stimulation of lettuce by exposure to Microbacterium sp. EC8.

| | | | | | High |
|---|---|---|---|---|---|
| | | Low density- | Low density- | High density- | density- |
| | | Single | Two | Single | Two |
| | Control | addition | additions | addition | additions |
| Shoot fresh weight (mg) | 500 | 620 | 650 | 580 | 690 |
| Shoot fresh weight (%) | 100 | 120 | 125 | 112 | 138 |
| Shoot dry weight (mg) | 25 | 28 | 30 | 26 | 30 |
| Shoot dry weight (%) | 100 | 118 | 121 | 102 | 122 |

### Example 12: Biostimulant Effect on Tomato Through Soil Inoculation

The same experiment as specified for lettuce in Example 11 were also carried out for tomato cv. minibel, with as differences that 5 plants were present per pot and that the harvest took place after 17 days. Results are shown in Table 6.

TABLE 6
Growth stimulation of tomato by exposure to Microbacterium sp. EC8.

| | | | | | High |
|---|---|---|---|---|---|
| | | Low density- | | High density- | density- |
| | | Single | Low density- | Single | Two |
| | Control | addition | Two additions | addition | additions |
| Shoot dry weight (mg) | 15 | 28 | 32 | 31 | 36 |
| Shoot dry weight (%) | 100 | 180 | 200 | 200 | 220 |

It is apparent from the data that the growth promotion in tomato is highly significant. This applies not merely to the high density addition, but also to the low density addition. The benefit of the second addition after 1 week is about 10% relative to the single addition. This again suggests the presence of a priming effect. However, the overall effect is so significant that contribution of other mechanisms of growth promotion cannot be excluded.

### Example 13: Enhanced Germination of Tomato Seeds

During the experiment described in Example 12, furthermore the germination rate was reviewed, both after 7 days and at harvest (17 days). It was apparent that the germination after 7 days was highly increased. At harvest, the difference was less big but still present. Results are shown in Table 7.

TABLE 7
Germination rate of tomato by exposure to Microbacterium sp. EC8.

| | | Low density- | | | High density- |
|---|---|---|---|---|---|
| | | Single | Low density- | High density- | Two |
| | Control | addition | Two additions | Single addition | additions |
| Count at 7 days (%) | 24 | 88 | 80 | 78 | 76 |
| Count at 17 days (%) | 82 | 96 | 98 | 93 | 96 |

### Example 14: Enhanced Growth of Basil

The experiment was carried out wherein the bacterial composition of Microbacterium sp. EC8 was inoculated twice at the density of 10⁷ CFU/ml soil. Additionally a control treatment without Microbacterium sp. EC8 was carried out. Use was made of 100% potting soil, in which a fertilizer was added (NPK 12-14-24 at 0.7 g/liter) and with 1 plant/pot and 40 replicates. The growth took place in a greenhouse. Tests were carried out wherein the bacterial composition was added to the soil at sowing and 1 week after sowing. From the second week after sowing, a liquid NPK fertilizer (35.2 ml nutrient solution/pot/week) was provided to the plants at a rate of 8 mg N/pot/week. Table 8 shows the results of shoot biomass at harvesting 30 days after sowing.

TABLE 8
Growth stimulation of basil by exposure to Microbacterium sp. EC8.

| | Shoot fresh weight (g) | Shoot fresh weight (%) |
|---|---|---|
| Control | 7.85 | 100 |
| EC8 | 8.48 | 108 |

It is apparent from the data that the growth promotion in basil is highly significant. The benefit is especially important as the plants received high fertilizer levels. This indicates that even in highly favorable nutrient conditions, a strong and significant biostimulant effect can be observed.

Thus, in summary, the invention relates to a bacterial composition and the use thereof, which bacterial composition comprises at least one plant growth-promoting bacterium from the Microbacterium genus, for producing biostimulant effects in seeds, seedlings and/or plants, comprising the step of priming said seeds, or seedlings or plants. The bacterial composition particularly comprises Microbacterium strains EC8, W283, EC19, W211, W219, W269, W236, and EC6 (Table 1), and all strains sharing at least 98% sequence homology to Microbacterium strain EC8 at the 16S rRNA gene nucleotide sequence level. The bacterial composition is particularly applied to a growth medium, for instance before transplantation. Very good results have been obtained for tomato plants. This relates to an increase in the germination rate, and/or an increase in shoot biomass in seedlings, and/or an increase in root biomass in seedlings. The shoot increase particularly occurs in seedlings in a period between sowing and two weeks thereafter, and/or wherein the biostimulant effect is based on priming. The Microbacterium sp. EC8 bacteria is deposited under the Budapest treaty and the 16S rRNA gene sequences of the Microbacterium strains EC8, W283, EC19, W211, W219, W269, W236, and EC6 are included in Table 1.

### REFERENCES

Bindea et al., Bioinformatics 25(2009): 1091-1093.
Blom et al., Environ Microbiol 13(2011): 3047-3058.
Chin et al., Nat Meth 10 (2013): 563-569.
Cordovez et al., Frontiers in Microbiology 6(October 2015):1081; doi: 10.3389/fmicb.2015.01081.
Felsenstein, Evolution 39(1985): 783-791.
Hernández-Léon et al., Biol Control 81(2015): 83-92.
Langmead & Salzberg, Nat. Meth. 9 (2012): 357-359.
Letunic & Bork, Nucleic Acids Res 39(2011): W475-W478.
Letunic & Bork, Nucleic Acids Res 2016, 44(W12016): W242-W245.
Li & Dewey, BMC Bioinform 12 (2011): 1-16.
Love et al., Genome Biology 15 (2014): 1-21.
Mendes et al., Science 332(6033), 2011): 1097-1100.
Murashige & Skoog, Phys Plant, 15 (1962): 473-497.
Ryu et al., Proc Natl Acad Sci USA 100(2003), 4927-4932.
Saitou & Nei, Mol Biol Evol 4(1987): 406-425
Tamura & Nei, Mol Biol Evol 10(1993): 1073-1095.
van de Mortel et al., Plant Physiol 160(2012): 2173-2188.

1-15. (canceled)

16. A bacterial composition comprising at least one Microbacterium strain, said composition having a plant-growth promoting effect upon administration to seeds, seedlings and plants, wherein the Microbacterium strain is chosen from the strains EC8, EC19, W283 or any other strain with a genetic correspondence to EC8 based on 16S rRNA gene sequence of at least 98%.

17. A method for producing biostimulant effects in seeds, seedlings and/or plants, comprising the step of priming said seeds, or seedlings or plants with a bacterial composition comprising at least one plant growth promoting bacterium strain from the Microbacterium genus,
wherein the Microbacterium strain is chosen from the strains EC8, EC19, W283 or any other strain with a genetic correspondence to EC8 based on 16S rRNA gene sequence of at least 98%, wherein the Microbacterium bacteria comprise genes for production of volatile organic compounds, via which the priming occurs,
wherein the seed, seedling or plant is exposed to the Microbacterium strain(s) by inoculation of the bacterial composition on or into a germination or growth medium at conditions at which the said bacterium from the Microbacterium genus produce volatile organic compounds (VOCs) and wherein the produced VOCs can reach the seeds, seedlings or plants.

18. The method as claimed in claim 17, wherein the VOCs are Sulphur-containing VOCs.

19. The method as claimed in claim 17, wherein the priming of the seeds, seedling or plants occurs by seed, root or root primordia exposure, without the need of direct contact of the bacteria with the seed, seedling or plant respectively and without seed, seedling or plant colonization.

20. The method as claimed in claim 17, wherein the seed, seedling or plant is chosen from the Solanaceae family, the Asteraceae family, the Brassicaceae family and the Lamiaceae family.

21. The method as claimed in claim 20, wherein the seed, seedling or plant is chosen from the Solanum genus within the Solanaceae family.

22. The method as claimed in claim 21, wherein the seed, seedling or plant is a tomato seed, seedling or plant.

23. The method as claimed in claim 20, wherein the seed, seedling or plant is chosen from the Cichorieae of the Cichorioideae subfamily of the Asteraceae family.

24. The method as claimed in claim 23, wherein the seed, seedling or plant is lettuce.

25. The method as claimed in claim 20, wherein the seed, seedling or plant is chosen from the Lamiaceae family.

26. The method as claimed in claim 25, wherein the seed, seedling or plant belongs to the group of basil (Ocimum basilicum).

27. The method as claimed in claim 17, wherein the seed or seedling is exposed to the Microbacterium bacteria, when the seedlings have an age of 0-14 days after sowing or after plants obtained from vegetative multiplication or micro-propagation are transferred in a new growth medium.

28. The method as claimed in claim 17, wherein priming is carried out by root or root primordia exposure of adult plants.

29. The method as claimed in claim 17, wherein inoculation of the germination or growth medium is repeated.

30. A method for producing biostimulant effects in plants from the Solanum genus within the Solanaceae family, wherein use is made of a bacterial composition as claimed in claim 1, comprising at least one plant growth-promoting bacterial strain from the Microbacterium genus, said composition having a plant-growth promoting effect upon administration to seeds, seedlings and plants, wherein the Microbacterium strain is chosen from the strains EC8, EC19, W283 or any other strain with a genetic correspondence to EC8 based on 16S rRNA gene sequence of at least 98%.

31. The method as claimed in claim 30, wherein the plant is a tomato plant.

32. The method as claimed in claim 30, wherein the bacterial composition is added to the growth medium, in which seeds or seedlings are sown or planted.

33. The method as claimed in claim 32, wherein the bacteria from the Microbacterium genus are applied at a density of 5.10³-5.10⁷ cells/gram of soil, substrate or growth matrix.

34. The method as claimed in claim 33, wherein, the bacteria from the Microbacterium genus are applied at a density of 5.10⁵-5.10⁶ cells/gram of soil, substrate or growth matrix.
